(19) United States
(12) Patent Application Publication
(10) Pub. No.: US 2026/0135720 A1
(43) Pub. Date: May 14, 2026

(54) INTEGRATED CIRCUIT AND METHOD FOR GENERATING A SECRET DATA STRING

(71) Applicant: STMicroelectronics International N.V., Geneva (CH)

(72) Inventors: Francesco La Rosa, Rousset (FR); Pascal Fornara, Pourrières (FR); Marc Mantelli, Fuveau (FR)

(21) Appl. No.: 19/351,018

(22) Filed: Oct. 6, 2025

(30) Foreign Application Priority Data
Nov. 13, 2024 (FR) FR2412363

(51) Int. Cl. H04L 9/32; H04L 9/08; H10B 43/35; H10B 80/00

(52) U.S. Cl. CPC H04L 9/3278; H04L 9/0861; H10B 43/35; H10B 80/00; H04L 2209/12

(57) ABSTRACT

An integrated circuit includes a combination circuit configured to generate a secret data string combining first digital information and second digital information, and, in a same memory plane, at least one first entropy cell is configured to supply the first digital information determined by a physical unclonable function of the first entropy cell. At least one second memory cell is configured to supply the second digital information determined by a charge contained in a non-volatile manner in a floating gate of a state transistor, the floating gate of the state transistor being furthermore connected to at least one metal track of an interconnection part of the integrated circuit.

### CROSS-REFERENCE TO RELATED APPLICATIONS

This application claims the benefit of French Patent Application No. 2412363, filed on November 13, 2024, which application is hereby incorporated herein by reference.

### TECHNICAL FIELD

Embodiments and implementations relate to an integrated circuit and method for generating a secret data string, and in particular protection for preventing retrieval of the secret data string by reverse engineering techniques.

### BACKGROUND

There are techniques, called reverse engineering, capable of dismantling integrated circuits and deriving therefrom observations making it possible to reproduce their structures and operations, and in particular to extract data, potentially secret, recorded in non-volatile memories.

The data recorded in non-volatile memories can be retrieved by so-called "back door" attacks, in which it is possible to machine and etch, typically by focused ion beam ("FIB"), the semiconductor substrate of an electronic chip until the active regions of the functional semiconductor circuit are reached. Microscopy analyses, such as atomic force microscopy ("AFM"), can then make it possible to measure the electrical characteristics, such as a capacitive value or a current, of a transistor, for example in the channel region thereof.

The data recorded in non-volatile memories are also vulnerable (retrievable) by so-called "front door" attacks, in which metal levels of the interconnection part of the electronic chip, delaminated successively by polishings and etchings, are observed. Baring the metal tracks makes it possible to establish electrical contacts therein with nanometric probes (by "nanoprobing") and to probe the electrical behavior of a transistor for example.

The information obtained in these two types of attack, front door or back door, can make it possible to extract or reconstruct digital data recorded in a non-volatile memory.

### SUMMARY

Thus there is a need to reduce the vulnerability of so-called "secret" data, recorded in a non-volatile memory, to reverse-engineering attacks.

In this regard, embodiments and implementations are proposed wherein a secret data string is formed by combining first digital information destroyed and lost in the case of implementation of a back-door attack, and second digital information destroyed and lost in the case of implementation of a front-door attack.

Thus each of the back-door or front-door attacks results in a loss of part of the secret, independently of the fact that it can allow extraction of another part of the secret, so that it is impossible to extract the complete secret.

In other words, it is proposed not to prevent or make difficult the implementation of the back-door or front-door attacks, but to make them useless with regard to the secret.

According to one aspect, an integrated circuit is proposed in this regard, including a combination circuit configured to generate a secret data string combining first digital information and second digital information, and, in one and the same memory plane: - at least one first entropy cell configured to supply the first digital information determined by a physical unclonable function of the first entropy cell; - at least one second memory cell configured to supply the second digital information determined by a charge contained in a non-volatile manner in a floating gate of a state transistor, the floating gate of the state transistor being furthermore connected to at least one metal track of an interconnection part of the integrated circuit.

The first entropy cell can thus for example be functionally destroyed by a back-door attack; while the second memory cell is configured specifically in order to lose the second digital information in the case of a front-door attack.

The second memory cell has a normal non-volatile memory-cell behavior in which the second digital information can be written and read in nominal usage of a non-volatile memory, however any external intervention on the metal track connected to the floating gate irreversibly affects the charge on the floating gate and causes loss of the second digital information.

According to one embodiment, the first entropy cell includes at least one transistor, and the physical unclonable function results from a statistical drift of an electrical characteristic of the at least one transistor of the first entropy cell.

For example, the effective threshold voltage of a transistor is an electrical characteristic the statistical drift of which can provide a physical unclonable entropy source able to determine data of the first digital information.

According to one embodiment, a differential read circuit is configured to supply the first digital information by detecting the polarity of a difference between currents that have flowed through two first entropy cells of an identified pair.

According to one embodiment: - at least one third memory cell is configured to contain third digital information provided for identifying and selecting, in the memory plane, first entropy cells (CEL1) that guarantee the stability and reliability of the first digital information.

According to one embodiment: - the at least one first entropy cell includes an equivalent single-gate transistor comprising a first gate and a second gate superimposed and electrically connected, and, in series, an access transistor including a vertical gate buried in a semiconductor substrate and a conduction region implanted in depth in the substrate; - the at least one second memory cell includes a state transistor comprising a superimposed floating gate and control gate, and, in series, and access transistor including a vertical gate buried in a semiconductor substrate and a conduction region implanted in depth in the substrate.

This type of cell including an access transistor thus buried vertically in depth in the substrate causes a destruction of the cell reading function in the case of back-door attack. The reading is done by a current that has flowed through a conduction path located in the depth of the substrate and which is broken by a back-door attack.

According to another aspect, a method is proposed for generating a secret data string combining first digital information and second digital information, wherein: - the first digital information is determined by a physical unclonable function of at least one first entropy cell of a memory plane; - the second digital information is determined by a charge contained in a non-volatile manner in a floating gate of a state transistor of at least one second memory cell of the memory plane, the floating gate being furthermore connected to at least one metal track of an interconnection part of the integrated circuit.

According to one embodiment, the physical unclonable function results from a statistical drift of an electrical characteristic of at least one transistor of the first entropy cell.

According to one implementation, the first digital information is supplied by detecting the polarity of a difference between currents that have flowed through two first entropy cells of an identified pair.

According to one implementation: - third digital information, contained in at least one third memory cell, is provided for identifying and selecting, in the memory plane, first entropy cells that guarantee the stability and reliability of the first digital information.

According to one implementation: - the at least one first entropy cell includes an equivalent single-gate transistor comprising a first gate and a second gate superimposed and electrically connected, and, in series, an access transistor including a vertical gate buried in a semiconductor substrate and a conduction region implanted in depth in the substrate; - the at least one second memory cell includes a state transistor comprising a superimposed floating gate and control gate, and, in series, an access transistor including a vertical gate buried in a semiconductor substrate and a conduction region implanted in depth in the substrate.

### BRIEF DESCRIPTION OF THE DRAWINGS

Other advantages and features of the invention will become apparent upon examining the detailed description of non-limiting embodiments and implementations, and from the accompanying drawings, wherein figures:

FIG. 1 illustrates an integrated circuit cross section in plane XZ;

FIG. 2 illustrates the integrated circuit cross section in plane YZ;

FIG. 3 illustrates a plan view of a memory plane in plane XY; and

FIG. 4 illustrates functional generation of a secret data string protected against reverse-engineering attacks.

### DETAILED DESCRIPTION OF ILLUSTRATIVE EMBODIMENTS

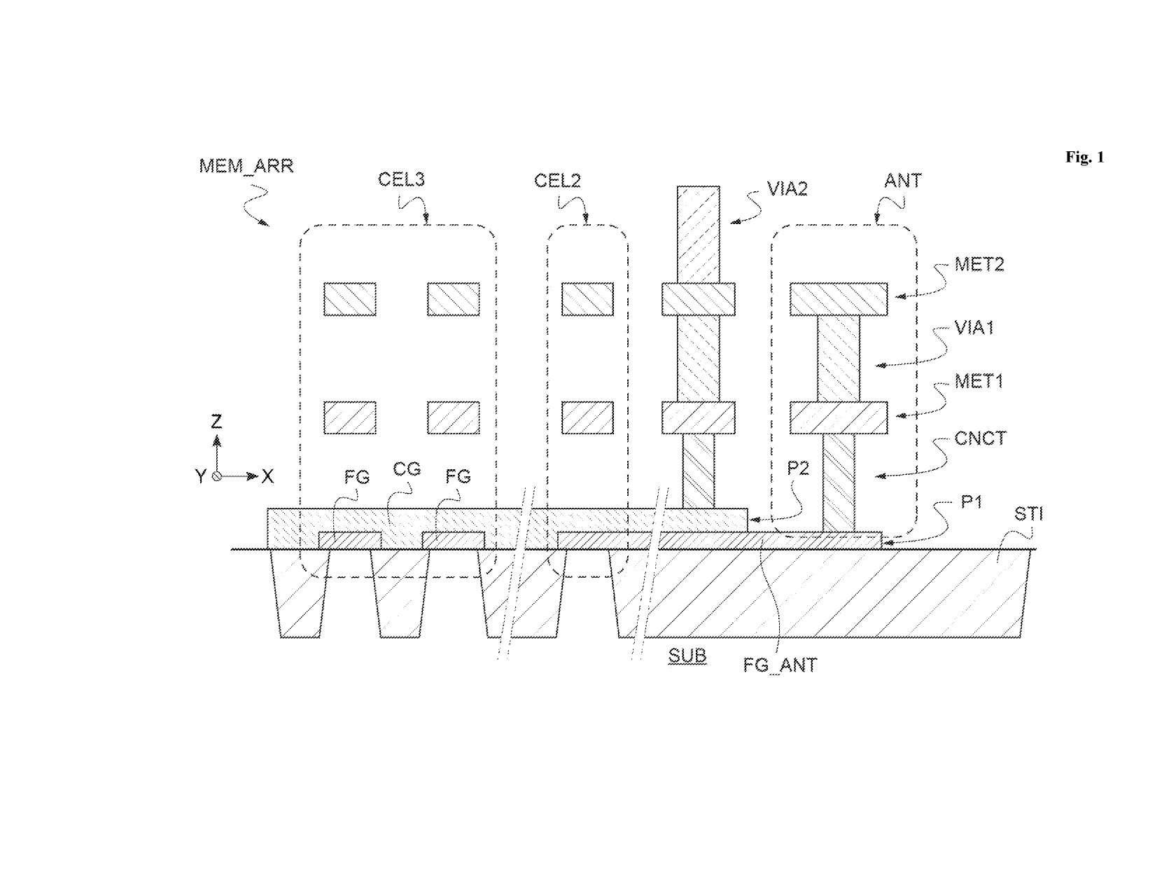

FIGS. 1, 2 and 3 illustrate an example of an integrated circuit including a memory plane MEM_ARR of a non-volatile memory, including cells CEL1, CEL2, CEL3. The orientation of each figure is given by an orthogonal reference frame XYZ common to FIGS. 1, 2 and 3.

FIG. 1 illustrates a view in cross section in a plane XZ, where X is the direction of the word lines and rows of the memory plane MEM_ARR, and Z is the vertical direction.

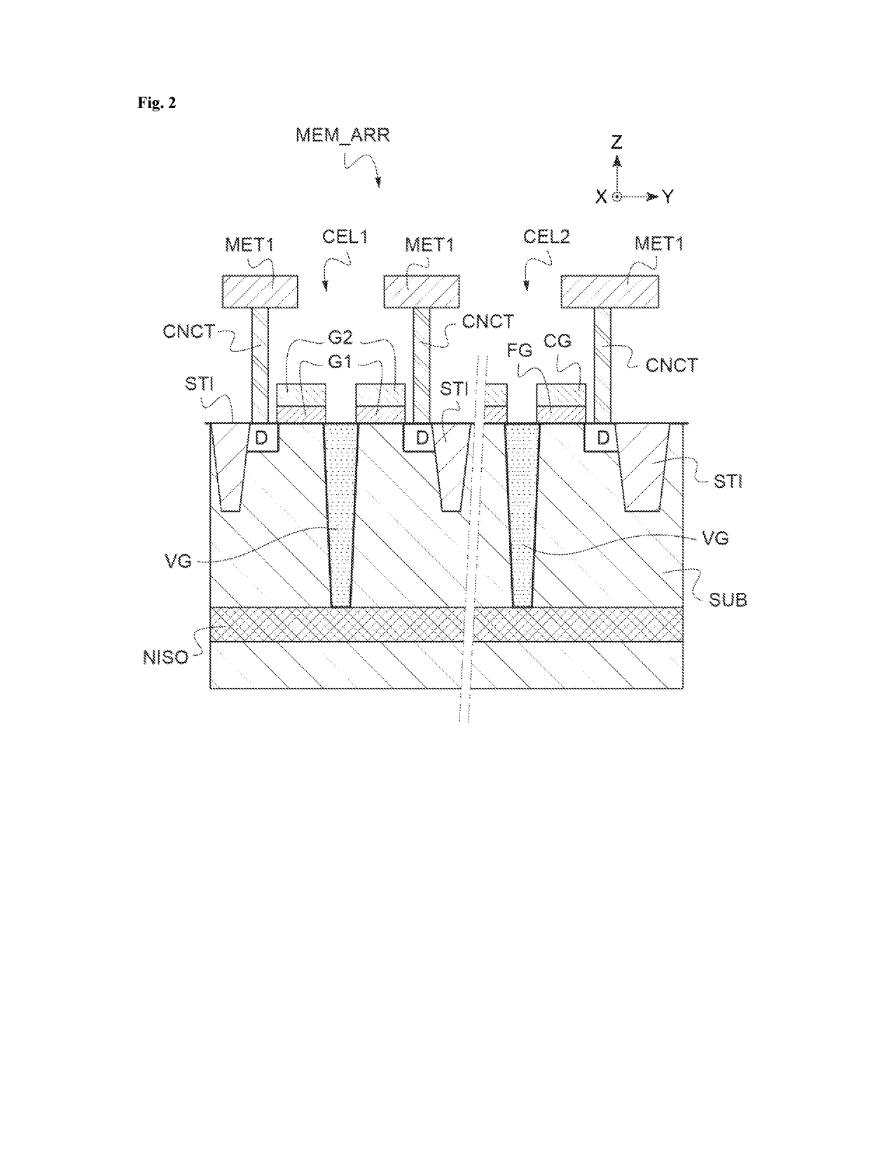

FIG. 2 illustrates a view in cross section in a plane YZ, where Y is the direction of the bit lines and columns of the memory plane MEM_ARR, and Z is the vertical direction.

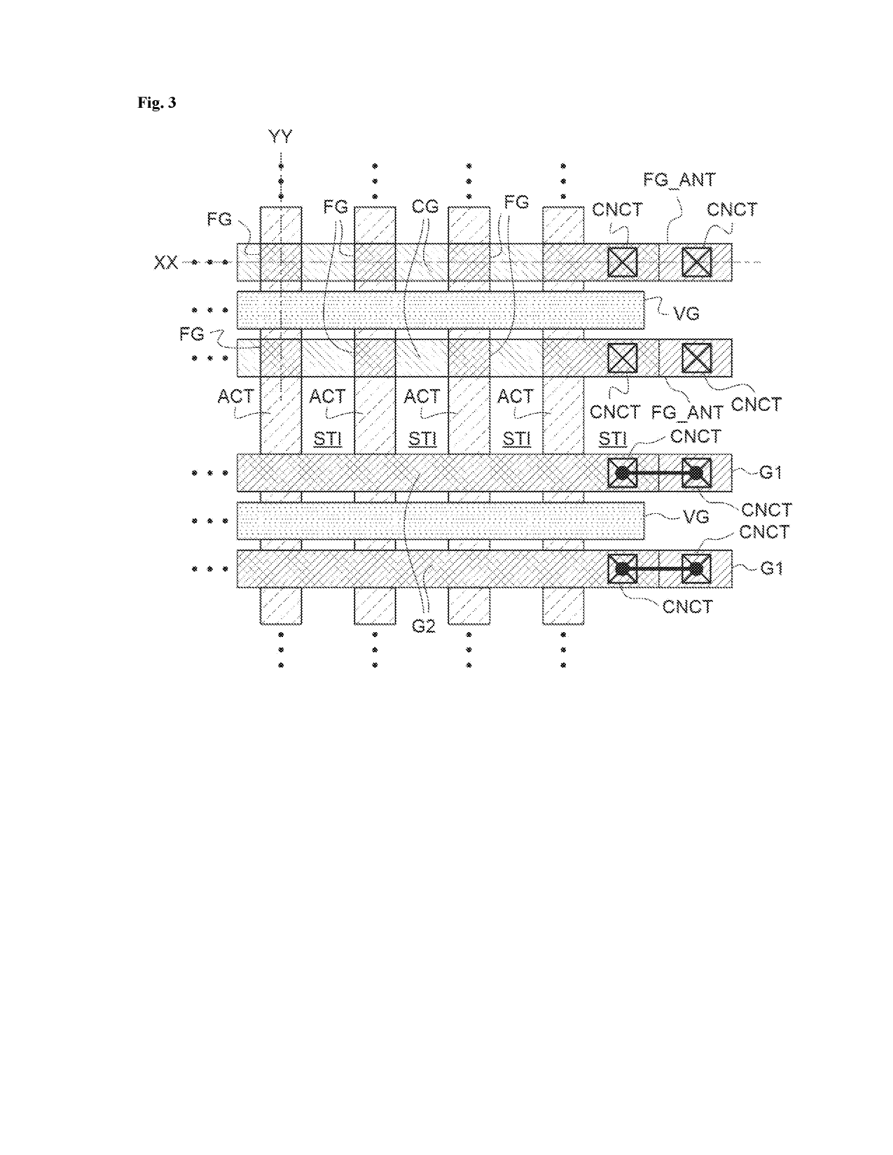

FIG. 3 illustrates a plan view of the memory plane MEM_ARR, in a plane XY, on which the cutting plane of FIG. 1 is positioned by an axis line XX, and on which the cutting plane of FIG. 2 is positioned by an axis line YY.

The cells CEL1, CEL2, CEL3 are structurally similar to memory cells of a non-volatile memory. The memory cells CEL1, CEL2, CEL3 each comprise a double-gate transistor, of the state transistor type, including a superimposition of a first gate structure G1 and of a second gate structure G2, typically each comprising a conductive layer of polycrystalline silicon P1, P2 on a dielectric layer, coupled in series with an access transistor.

As for the access transistor, this includes a vertical gate VG buried in the semiconductor substrate SUB and a conduction region NISO implanted in depth in the substrate. The conduction region NISO is for example incorporated in a source plane common to several cells.

Among the cells of the memory plane MEM_ARR, first memory cells (at least one) CEL1, called entropy cells, include an implementation of an equivalent single-gate transistor, electrically connecting together the superimposed first gate G1 and second gate G2.

Among the cells of the memory plane MEM_ARR, second and third cells CEL2, CEL3, called memory cells, conventionally include a state transistor comprising a superimposed floating gate FG and control gate CG.

The memory plane MEM_ARR is implemented in a region of the integrated circuit (called "FEOL", standing for "Front End Of Line") located in and on a front face of the semiconductor substrate SUB.

Above the front-face region of the "FEOL" region is an interconnection region of the integrated circuit (called "BEOL", standing for "Back End Of Line"), including metal tracks formed in successive layers of metal levels MET1, MET2 and of vias VIA1, VIA2 passing vertically through inter-metal dielectrics.

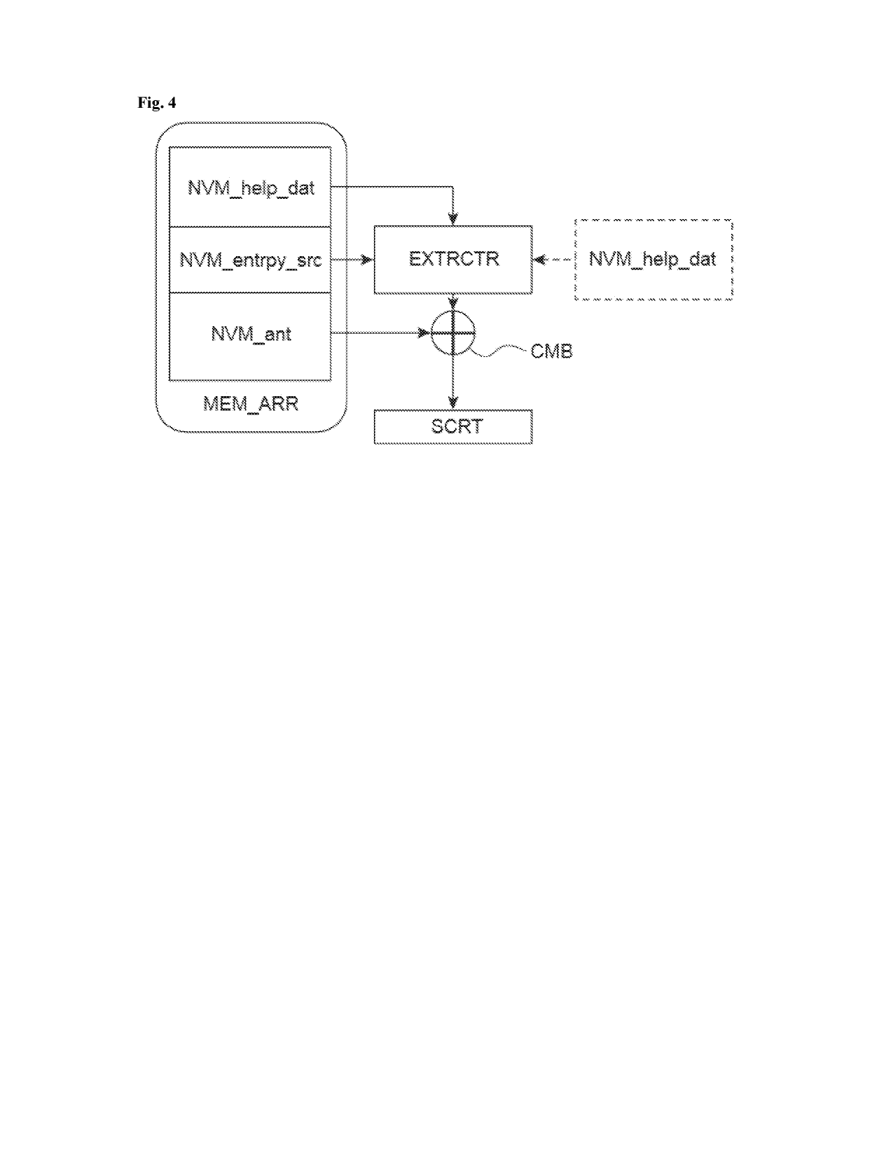

The integrated circuit is configured to generate a secret data string combining first digital information supplied by at least one first entropy cell CEL1 and second digital information supplied by at least one second memory cell CEL2, for example by means of a retrieval circuit (retrieving the first digital information) EXTRCTR and by means of a combination circuit CMB (FIG. 4).

"Digital information" means a string of digital data, including at least one bit, advantageously a plurality of bits, for example 64 bits, 128 bits, 256 bits or more and without particular limit depending on the usage of the secret data string.

The combination of the first digital information and of the second digital information can for example be a bitwise "Exclusive OR" logic operation between all or part of the first digital information and of the second digital information.

Hereinafter, it is considered that the first digital information is supplied in several bits by several first entropy cells CEL1, and likewise that the second digital information is supplied in several bits by several second memory cells CEL2.

Firstly, the first entropy cells CEL1 are configured so that the first digital information is irreversibly lost in the case of implementation of a back-door attack; i.e. for example a localized etching (typically by focused ion beam), approaching the front face of the semiconductor substrate SUB, by the rear, through the substrate SUB from the face of the substrate SUB opposite to the front face.

Secondly, the second memory cells CEL2 are configured so that the second digital information is irreversibly lost in the case of implementation of a front-door attack; i.e. for example in the case of an attack, usually by polishings and etchings, in the metal levels VIA2, MET2, VIA1, MET1 of the interconnection part of the electronic chip.

With regard to the firstly expressed above, the first entropy cells CEL1 are configured to supply the first digital information determined by a physical unclonable function of the first memory cell.

A physical unclonable function (usually "PUF") is a physical object the operation of which cannot be reproduced physically and which, for a given input or conditions (called a "challenge"), supplies a definite invariable response.

For example, the physical unclonable function results from a statistical drift of an electrical characteristic of at least one transistor of the first entropy cell CEL1. This characteristic varies from one implementation to another of structurally identical devices, and is neither predictable nor reproducible. However, this characteristic does not vary during the life of a given implementation.

The electrical characteristic is advantageously the effective threshold voltage of the equivalent single-gate transistor, produced by electrical contact between the first gate G1 (structurally similar to a floating gate) and the second gate (structurally similar to a control gate).

So that the effective threshold voltage is distinguishing, the measurement can be made differentially between two cells of an identified pair of first entropy cells CEL1.

A differential read circuit can advantageously be configured to read the bit (0 or 1) defined by a pair of first entropy cells, by controlling the two cells under the same reading conditions, and by measuring the difference between the reading currents that have flowed through each of the first cells of the pair.

Thus the polarity (i.e. the positive or negative sign) of the difference between the currents that have flowed will define a bit (for example respectively 0 and 1).

For example, if the intensity of the reading current of the first cell in the pair is higher than the intensity of the reading current of the second cell, then the pair defines a "0"; and conversely, if the intensity of the reading current of the first cell of the pair is lower than the intensity of the reading current of the second cell, then the pair defines a "1".

The reading current circulates substantially from the buried source region NISO, through a conduction channel formed in the substrate SUB along the vertical gate VG of the controlled access transistor that is on under reading conditions, then through a conduction channel formed in the substrate SUB facing the stack of gates G1, G2 of the equivalent transistor controlled in ohmic regime under reading conditions, as far as a drain region D connected CNCT to a bit line formed in a metal level MET1 pre-charged to a reading potential.

Consequently, any attack on the region of the substrate SUB located vertically between the buried conduction region NISO and the gates of the transistors of the entropy cells CEL1 (but also the memory cells CEL2), in particular by focused ion beam ("FIB"), will attack the transit of the reading current and will destroy the physical unclonable function of the first entropy cells CEL1.

The identifications of the pairs of first entropy cells CEL1 as "reliable", i.e. providing a distinguishing difference, can be measured during a test phase in the manufacture of the integrated circuit, for example in order to exclude pairs having by chance characteristics that are too close to be distinguished reliably and durably.

Advantageously, the associations of pairs of first entropy cells CEL1 can be done between entropy cells CEL1 spatially distant from each other.

A reading margin, i.e. a minimum deviation between the two intensities measured to be usable, can also be provided. The pairs of unusable transistors, which have threshold voltages close to each other (and consequently have differences in reading currents below the deviation) can be identified as such, or simply ignored and not form part of the usable pairs identified.

The identification of the reliable pairs of first entropy cells CEL1, called "mask" or "assistance data", can be contained in third information recorded in a dedicated memory NVM_help_dat, for example at a reserved location of the memory plane MEM_ARR.

Thus, for example, at least one third cell CEL3, of the conventional memory cell type of the memory plane MEM_ARR, is configured to contain third digital information NVM_help_dat provided for identifying, among the cells of the memory plane MEM_ARR, the first digital information.

With regard to the secondly expressed above, the second cells CEL2, called memory cells, are configured to supply the second digital information determined by a charge contained in a non-volatile manner in the floating gate FG_ANT of the state transistor.

The floating gate FG_ANT of the state transistor of each of the second memory cells CEL2 is furthermore connected to a structure of at least one metal track ANT in the interconnection part of the integrated circuit.

The structure of metal track or tracks ANT can be located in the first metal levels MET1, MET2 of the interconnection part "BEOL", and can extend without particular limitation in upper metal levels (up to around ten metal levels can be counted for example). The structure of metal track or tracks ANT is also floating, i.e. is not coupled to any electrical voltage, so as to maintain a floating potential.

The second memory cell CEL2 can operate according to a normal non-volatile memory cell behavior, in which the second digital information can be written and read in the nominal usage of a non-volatile memory cell of the memory plane MEM_ARR.

And furthermore the metal track structures ANT connected to the floating gate FG_ANT act as an antenna, able to take the electrical potential of any external element that contacts it, and necessarily affects the charge of the floating gate. Thus any external action on one of the metal tracks ANT connected to the floating gate FG_ANT causes the loss of the second digital information.

Thus, in summary, the first entropy cells CEL1 are firstly configured so that the first digital information is irreversibly lost in the case of implementation of a back-door attack; and the second memory cells CEL2 are secondly configured so that the second digital information is irreversibly lost in the case of implementation of a front-door attack.

Thus any attempt at retrieval (by reverse-engineering "attack") of one of the two sets of digital information causes the irreversible loss of the other set of digital information.

It is possible to guarantee a sufficiently great probability of reciprocal attack by positioning the first entropy cells CEL1 and the second memory cells CEL2 in the same memory plane MEM_ARR; for example by interlacing the positions of the first cells CEL1 and of the second cells CEL2 in the same memory plane MEM_ARR.

FIG. 4 illustrates functionally the implementation of the generation of the secret data string SCRT protected against reverse-engineering attacks both front door and back door.

The secret data string SCRT is obtained by combining first digital information NVM_entrpy_src and second digital information NVM_ant (for example by an Exclusive-OR operation). The digital information NVM_entrpy_src, NVM_ant is supplied by cells implemented in one and the same memory plane MEM_ARR.

The first digital information NVM_entrpy_src is determined by a physical unclonable function of at least one first memory cell, so as to be irreversibly lost in the case of implementation of a back-door attack.

The second digital information NVM_ant is determined by a charge contained in a non-volatile manner in a floating gate of a state transistor of at least one second memory cell of the memory plane, the floating gate being furthermore connected to at least one metal track of an interconnection part of the integrated circuit, so as to irreversibly lose the second digital information NVM_ant in the case of implementation of a front-door attack.

Finally, third digital information NVM_help_dat can be provided for identifying and selecting, among the pairs of first entropy cells CEL1 of the memory plane, those that guarantee the stability and the reliability of the first digital information NVM_entrpy_src.

The third digital information NVM_help_dat makes it possible for example to control the operations of a retrieval circuit EXTRCTR in order to access the first digital information VM_entrpy_src.

The retrieval circuit EXTRCTR, by reading the third digital information NVM_help_dat, selects the reliable part of the first information NVM_entrpy_src generated by the first entropy cells CEL1. The third information NVM_help_dat determines what is reliable or not among the first digital information NVM_entrpy_src. The third information NVM_help_dat is written in what corresponds to a map identifying the positions (addresses) in the memory plane NVM_ARR of the first entropy cells CEL1 that can supply the first reliable digital information NVM_entrpy_src.

Preferably, the third digital information NVM_help_dat is contained in some (at least one) third memory cells of the same memory plane MEM_ARR, but could also be recorded in another component of the integrated circuit (shown in broken lines as a non-preferential alternative).

A combination circuit CMB is configured to combine the first information NVM_entrpy_src thus retrieved, with the second information NVM_ant, for example by means of a bitwise Exclusive-OR combination between the first information and the second information.

What is claimed is:

1. An integrated circuit comprising:
a combination circuit configured to generate a secret data string combining first digital information and second digital information; and
in a same memory plane:
at least one first entropy cell configured to supply the first digital information determined by a physical unclonable function of the first entropy cell; and
at least one second memory cell configured to supply the second digital information determined by a non-volatile charge contained in a floating gate of a state transistor, wherein the floating gate of the state transistor is connected to at least one metal track of an interconnection part of the integrated circuit.

2. The integrated circuit according to claim 1, wherein the first entropy cell includes at least one transistor, and the physical unclonable function results from a statistical drift of an electrical characteristic of the at least one transistor of the first entropy cell.

3. The integrated circuit according to claim 2, wherein:
at least one third memory cell is configured to contain third digital information provided for identifying and selecting, in the same memory plane, first entropy cells that guarantee a stability and reliability of the first digital information.

4. The integrated circuit according to claim 2, wherein:
the at least one first entropy cell includes an equivalent single-gate transistor comprising a first gate and a second gate superimposed and electrically connected, and, in series, an access transistor including a vertical gate buried in a semiconductor substrate and a conduction region implanted in depth in the semiconductor substrate; and
the at least one second memory cell includes a second state transistor comprising a superimposed floating gate and control gate, and, in series, a second access transistor including a second vertical gate buried in the semiconductor substrate and the conduction region implanted in depth in the semiconductor substrate.

5. The integrated circuit according to claim 2, wherein a differential read circuit is configured to supply the first digital information by detecting a polarity of a difference between currents that have flowed through two first entropy cells of an identified pair.

6. The integrated circuit according to claim 5, wherein:
at least one third memory cell is configured to contain third digital information provided for identifying and selecting, in the same memory plane, first entropy cells that guarantee a stability and reliability of the first digital information.

7. The integrated circuit according to claim 5, wherein:
the at least one first entropy cell includes an equivalent single-gate transistor comprising a first gate and a second gate superimposed and electrically connected, and, in series, an access transistor including a vertical gate buried in a semiconductor substrate and a conduction region implanted in depth in the semiconductor substrate; and
the at least one second memory cell includes a second state transistor comprising a superimposed floating gate and control gate, and, in series, a second access transistor including a second vertical gate buried in the semiconductor substrate and the conduction region implanted in depth in the semiconductor substrate.

8. The integrated circuit according to claim 1, wherein a differential read circuit is configured to supply the first digital information by detecting a polarity of a difference between currents that have flowed through two first entropy cells of an identified pair.

9. The integrated circuit according to claim 8, wherein:
the at least one first entropy cell includes an equivalent single-gate transistor comprising a first gate and a second gate superimposed and electrically connected, and, in series, an access transistor including a vertical gate buried in a semiconductor substrate and a conduction region implanted in depth in the semiconductor substrate; and
the at least one second memory cell includes a second state transistor comprising a superimposed floating gate and control gate, and, in series, a second access transistor including a second vertical gate buried in the semiconductor substrate and the conduction region implanted in depth in the semiconductor substrate.

10. The integrated circuit according to claim 1, wherein:
at least one third memory cell is configured to contain third digital information provided for identifying and selecting, in the same memory plane, first entropy cells that guarantee a stability and reliability of the first digital information.

11. The integrated circuit according to claim 1, wherein:
the at least one first entropy cell includes an equivalent single-gate transistor comprising a first gate and a second gate superimposed and electrically connected, and, in series, an access transistor including a vertical gate buried in a semiconductor substrate and a conduction region implanted in depth in the semiconductor substrate; and
the at least one second memory cell includes a second state transistor comprising a superimposed floating gate and control gate, and, in series, a second access transistor including a second vertical gate buried in the semiconductor substrate and the conduction region implanted in depth in the semiconductor substrate.

12. A method for generating a secret data string combining first digital information and second digital information by an integrated circuit, the method comprising:
determining the first digital information by a physical unclonable function of at least one first entropy cell of a memory plane; and
determining the second digital information by a non-volatile charge contained in a floating gate of a state transistor of at least one second memory cell of the memory plane, the floating gate being connected to at least one metal track of an interconnection part of the integrated circuit.

13. The method according to claim 12, further comprising supplying the first digital information by detecting a polarity of a difference between currents that flowed through two first entropy cells of an identified pair.

14. The method according to claim 13, further comprising providing third digital information, contained in at least one third memory cell, for identifying and selecting, in the memory plane, first entropy cells that guarantee a stability and reliability of the first digital information.

15. The method according to claim 13, wherein:
the at least one first entropy cell includes an equivalent single-gate transistor comprising a first gate and a second gate superimposed and electrically connected, and, in series, an access transistor including a vertical gate buried in a semiconductor substrate and a conduction region implanted in depth in the semiconductor substrate; and
the at least one second memory cell includes a second state transistor comprising a superimposed floating gate and control gate, and, in series, a second access transistor including a second vertical gate buried in the semiconductor substrate and the conduction region implanted in depth in the semiconductor substrate.

16. The method according to claim 12, wherein the physical unclonable function results from a statistical drift of an electrical characteristic of at least one transistor of the first entropy cell.

17. The method according to claim 16, further comprising providing third digital information, contained in at least one third memory cell, for identifying and selecting, in the memory plane, first entropy cells that guarantee a stability and reliability of the first digital information.

18. The method according to claim 16, further comprising supplying the first digital information by detecting a polarity of a difference between currents that flowed through two first entropy cells of an identified pair.

19. The method according to claim 12, further comprising providing third digital information, contained in at least one third memory cell, for identifying and selecting, in the memory plane, first entropy cells that guarantee a stability and reliability of the first digital information.

20. The method according to claim 12, wherein:
the at least one first entropy cell includes an equivalent single-gate transistor comprising a first gate and a second gate superimposed and electrically connected, and, in series, an access transistor including a vertical gate buried in a semiconductor substrate and a conduction region implanted in depth in the semiconductor substrate; and
the at least one second memory cell includes a second state transistor comprising a superimposed floating gate and control gate, and, in series, a second access transistor including a second vertical gate buried in the semiconductor substrate and the conduction region implanted in depth in the semiconductor substrate.
